(19) United States
(12) Patent Application Publication
(10) Pub. No.: US 2015/0295781 A1
(43) Pub. Date: Oct. 15, 2015

(54) CLOUD OBJECT

(71) Applicant: HEWLETT-PACKARD DEVELOPMENT COMPANY, L.P., Houston, TX (US)

(72) Inventor: Stephane Herman Maes, Fremont, CA (US)

(73) Assignee: Hewlett-Packard Development Company, L.P., Houston, TX (US)

(21) Appl. No.: 14/646,847

(22) PCT Filed: Dec. 3, 2012
(86) PCT No.: PCT/US2012/067594

§ 371 Date: May 22, 2015

(51) Int. Cl. H04L 12/24; G06F 3/0482; G06F 3/0484

(52) U.S. Cl. CPC H04L 41/22; H04L 41/12; G06F 3/0484; G06F 3/0482

(57) ABSTRACT

A cloud designer can generate a cloud object. The cloud designer can interact with an interface to provide a common design user experience (UE) for designing cloud elements on different layers of a cloud with a common syntax. The common syntax can be employable to express each cloud element of the cloud and to express relationships between cloud elements within and across layers of the cloud.

### BACKGROUND

Cloud computing is location-independent computing, whereby shared servers provide resources, platforms, software, and data to computers and other devices on demand. The term “cloud” is used as a metaphor for the Internet, based on the cloud drawing often used to represent computer networks. Cloud computing describes a supplement, consumption, and delivery model for information technologies services based on the Internet, and can involve over-the-Internet provision of dynamically scalable and often virtualized resources. One key characteristic of cloud computing is that the computing is “in the cloud” e.g. the processing (and the related data) is not in a specified, known or static place(s). Details are abstracted from consumers, who no longer have need for expertise in, or control over, the technology infrastructure “in the cloud” that supports them. This is in contrast to a model in which the processing takes place in one or more specific servers that are known.

### BRIEF DESCRIPTION OF THE DRAWINGS

FIG. 1 illustrates an example of a network system for generating a cloud object and instantiating an accessible cloud element.

FIG. 2 illustrates an example of a graphical user interface for generating a cloud object.

FIG. 3 illustrates an example of a flowchart of a method for instantiating an accessible cloud element.

FIG. 4 illustrates an example of a flowchart of a method for generating a cloud object.

FIG. 5 illustrates another example of a flowchart of a method for instantiating an accessible cloud element.

FIG. 6 illustrates another example of a system for generating a cloud object.

FIG. 7 illustrates another example of a flowchart of a method for generating a cloud object.

FIG. 8 illustrates an example of a computer system that can be employed to implement the systems and methods illustrated in FIGS. 1-7.

### DETAILED DESCRIPTION

A cloud designer can be utilized to generate a cloud object. The cloud object is a file that can be employed to instantiate an accessible cloud element on a cloud. As used herein, a “cloud element” denotes a resource (e.g., physical and/or virtual) resource of the cloud that can be accessed by another cloud element and/or by an external system (e.g., a client). The cloud object can have a plurality of model documents, each of which can include a specification that can be employed by a provisioning engine to instantiate (e.g., deploy and/or provision) corresponding cloud components (e.g., capabilities offered as a service) that compose the designed cloud service. Layers of the cloud can include: hardware, infrastructure (e.g. computing, storage and network), platform (e.g. MW and databases), applications and services. The cloud object can also include data characterizing a relationship between cloud elements specified by the plurality of model documents. The cloud designer can provide a mechanism to ensure a common design user experience (UE) during the generation/design of the cloud elements at each layer.

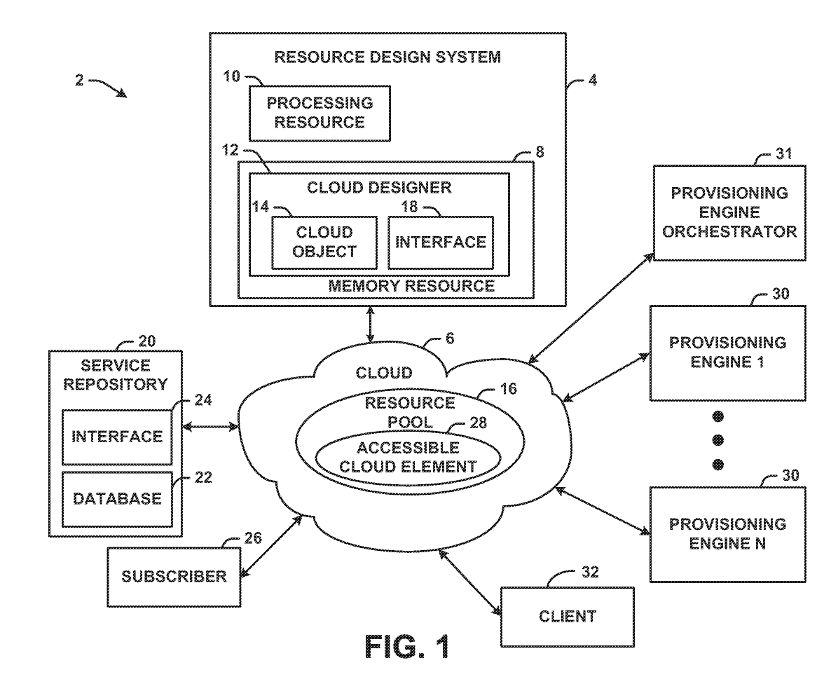

FIG. 1 illustrates an example of a system 2 for designing and implementing a cloud element. The system 2 can include a resource design system 4 that can be coupled to a cloud 6. The cloud 6 can be implemented, for example, as a public network (e.g., the Internet), a private network (e.g., a local area network) or a combination thereof (e.g., a hybrid cloud). The cloud design system 4 can be implemented, for example, as an application on a computer. In some examples, the application can be a web application executing on a server that can be accessed with a web browser or other client application. In such a situation, the resource design system 4 can include a memory resource 8 for storing machine-readable instructions. The memory resource 8 can be a non-transitory computer readable medium. The memory resource 8 could be implemented, for example, as volatile memory (e.g., random access memory), nonvolatile memory (e.g., a hard disk drive, a solid-state drive, flash memory, etc.) or a combination thereof. The memory resource 8 could be implemented on a single computer or distributed across a network fabric. The resource design system 4 can also include a processing resource 10 to access the memory 8 and execute the machine-readable instructions. The processing resource 10 can be implemented, for example, as a processor core. The processing resource 10 can be implemented on a single computer or be distributed across a network fabric.

The memory resource 8 can include a cloud designer 12 that can be employed to generate a cloud object 14 for the cloud. The cloud object 14 can be implemented as a data object that can be employed to implement a cloud element in a manner described herein. As explained herein, employment of the cloud designer 12 can provide a common design user experience (UE) for designing each layer of cloud object 14. In particular, each layer can have a data model that can be constituted of predefined cloud elements with possible configurations and operation on the predefined cloud elements. With the common design user experience, cloud elements of the cloud object 14 can be composed and configured by employing the same (or similar) “gestures” at each layer. For example, similar cloud elements can have the same taxonomy across each layer of the cloud object 14. Moreover, by employing the cloud designer 12, each layer can be extended and relationships between cloud elements on the same or different layers can be defined.

The cloud can be implemented on the cloud 6. The cloud can have different layers each modeled as a layer of abstraction. The design of each layer is expressed using a composition of cloud elements defined in an extensible data model associated to the layer. A given layer can depend on the functionality of some or all of the layers. The functionality of the given layer is also reflected in the models associated to each layer. Dependencies across layers can be conveyed by expressing relationships across the different layers of the cloud. For example, the relationships across the different layers can describe how a cloud element depends and/or is related to other cloud elements in the same or different layers of the cloud. For instance, the relationships can characterize how a cloud element leverages some particular types of cloud elements and/or value and/or value range of attributes of the cloud elements (e.g., a particular network, a particular OS, a particular set of capabilities, etc.).

For instance, a lowest layer of the cloud can be a hardware layer and associated to a hardware data model. The hardware data model can express physical resources of the cloud. The physical resources can include, for example, a list of hardware components (e.g., servers, switches, etc.) that provide resources to the cloud and a hardware configuration (e.g., a processor types, memory, network connections, etc.) of those hardware components. Additionally, the hardware data model can define a physical location of each hardware component that provides the resources to the cloud. The hardware data model can be used to express a designed set of hardware elements and their configuration details (e.g. via use of HP SERVICE ACTIVATOR™ (HP SA) available from the HEWLETT-PACKARD® Company). In some examples, the configuration details can be explicit, while in other examples, the configuration details can be variable and will be determined based on relationships with other cloud elements and/or based on contextual information (e.g. set by policies that check context values). It is noted that in some examples, such as a purely virtual solution, the hardware layer may not be included in a output cloud object.

A next layer on the cloud can be the infrastructure layer. The infrastructure layer can be associated to an infrastructure data model. The infrastructure layer defines the cloud elements that are made available as a service from the hardware components on the hardware layer, which can, in some examples, be referred to as infrastructure as a service (IaaS). For instance, due to overhead, a given server of the hardware layer may not expose 100% of the given servers available elements to the cloud. This may occur for a variety of reasons including, for example, redundancy and/or fault tolerance. As another example the given server may expose computing, storing and networking services. A dedicated designer can be used to specify the layer using the extensible data model associated to the infrastructure layer. As other example, the infrastructure layer may include cloud elements such as a virtual hard drive, a virtual machine (e.g., a virtual server), a virtual cluster of computers, an operating system, etc. It is noted that the cloud elements do not necessarily reflect physical allocation of resources. For instance, a virtual hard drive that is allocated to be 100 GB may be stored on a larger hard drive (e.g., 1 TB hard drive), and/or an array of hard drives of a physical server. In a similar manner, a single physical server may provide multiple virtual machine cloud elements. Conversely, a relatively powerful virtual machine may span multiple physical servers. However, such allocation of physical resources is not apparent at the infrastructure layer.

A next layer on the cloud can be referred to as a platform [platform as a service (PaaS)] layer and the corresponding data model. The platform layer can employ virtual hardware cloud elements of the infrastructure layer to implement a virtual computing platform that can, for example, include a programming language execution environment, a database, a web server, etc. The virtual computing platform could be employed, for example by application developers to develop and run software solutions on a cloud platform without the cost and complexity of buying and managing the underlying cloud layers. It is noted that in some examples, such as a purely virtual solution, the infrastructure layer may not be included in a given resulting cloud object designed with the designer and/or processed for instantiation or lifecycle management.

A next layer on the cloud can be referred to as an application [software as a service (SaaS)] layer and associated data model. The application layer can employ a virtual computing platform of the platform layer to install and operate cloud applications. In some examples, a cloud application can clone tasks onto multiple virtual machines at run-time to meet a changing work load demand. In one example, the application layer may be implemented as an office suite application, a social networking website, backup software, etc.

A next (and highest) layer on the cloud can be referred to as a services layer and corresponding data model. The services layer can leverage applications on the platform layer to provide a specific service. For instance, the services layer can be implemented as an automated backup system that employs backup software implemented on the application layer.

The cloud can include a resource pool 16 that can include a plurality of cloud elements. In the present example, for purposes of simplification of explanation, only one resource pool 16 is illustrated and described. However, in other examples (e.g., a hybrid deployment), the resource pool 16 can be representative of multiple resource pools that can be implemented in a similar or different manner as the resource pool 16. Each cloud element can be implemented, for example, as an instantiation of a cloud object (such as the cloud object 14) at a particular layer of the cloud.

Components of the system 2 (including the component resource pool 16, can be implemented, for example as machine readable instructions stored on a memory resource. In such a situation, the memory resource can be implemented, for example, as a volatile memory (e.g., random access memory), non-volatile memory (e.g., a hard drive, a solid state drive, flash memory, etc.). Moreover, the system can include a processing resource (e.g., a processor core) to access the memory resource and execute the machine readable instructions. Moreover, in the present examples, the memory resource and the processing resource could be stored a single machine (e.g., a computer) or across multiple computers (via a network).

The cloud designer 12 can include an interface 18, such as a graphical user interface (GUI) that provides a user with a medium to define a specification for the cloud object 14 at each layer of the cloud or some subset thereof. The specification for each layer can define features in the data model associated to the components in that layer involved in composing the cloud object/cloud elements (or combination of cloud objects/cloud elements). The specification for each layer cloud element can be stored in a corresponding document, which document can be referred to as a model document for the layer (for the designed object or combination of objects). The specification can be expressed, conveyed and stored in a standardized language such as the Oasis Technical Committee on topology and orchestration specification for cloud applications (TOSCA) language or in any other format that can support expression of the models (at each layer) and relationships between cloud elements within and across layers. The cloud object 14 can also include data that characterizes relationship between a given layer and other layers. For instance, the cloud object 14 that can include a model document corresponding to an infrastructure layer cloud element that can have data that characterizes the relationship between the infrastructure layer cloud element, and a hardware layer cloud element. In some examples, each of the model documents can be linked (e.g., integrated) together and stored in the cloud object 14 (e.g., as a single file). In other examples, the cloud object 14 can include a reference to each of the model documents, and the model documents can be stored separately from the cloud object 14. Further, in some examples, a given model document of the cloud object 14 can include a reference to another artifact that can be employed by a provisioning engine during an instantiation of a cloud element of cloud object associated with the given model document. For instance, the given model document could refer to a script, a source, etc. (or other artifact) that could be stored at a web link, in another document and/or in a database (e.g., an external database or to a database that is common to all layers).

In some examples, the cloud object 14 can include a model document for a combination of cloud elements in each (or a subset of) layer of the cloud. For instance, in one example, the cloud object 14 could include a model document for the hardware layer related to a services model. In other examples, the cloud object 14 can include a model document for a given layer, and a model document for each layer that is lower than the given layer. For instance, in one example, the cloud object 14 can include a model document for the platform layer, the infrastructure layer and the hardware layer, along with relationships between the cloud elements contained in each of the layer model documents generated by the cloud designer 12. In still other examples, the cloud object 14 can include a model document for a subset of the layers of the cloud. For instance, in one example, the cloud object 14 can include a model document for the application layer, the platform layer and the infrastructure layer.

Upon completion of the design of the cloud object 14, the cloud object 14 can be provided to a service repository 20 via the cloud 6. The service repository 20 can include, for example, a database 22 that can store the cloud object. Additionally, the service repository 20 can include an interface 24 that can provide access to the cloud object 14 stored in the database 22 of the service repository 20.

In one example, the interface 24 of the service repository 20 could be exposed as a catalog. The catalog can include, for example, commercial/usage terms added to the cloud object 16 in the service repository 20. The commercial/usage terms can include, but are not limited to, price, a service license agreement (SLA), a policy, etc. The catalog can be implemented in, for example, as a web interface, such as a marketplace/storefront. In such a situation, the marketplace could include a list of cloud objects available for ordering the provisioning/deployment and the management of the cloud object, which list could include the cloud object 14 generated by the resource design system 4. A subscriber 26 (e.g., a customer via a computer browser or application via interfaces (e.g. APIs) of the subscriber 26) can access the service repository 20 via the marketplace. In some examples, an application via an interface can be programmed and/or configured to order, provision, deploy and/or manage the cloud object 14. The marketplace could be implemented, for example, by a system that can offer unified solution to broker and/or manage a lifecycle of cloud elements. For instance, in some examples, the marketplace can be implemented by the HEWLETT PACKARD CLOUD SERVICE ACTIVATOR™ (HP CSA) system which is available from the HEWLETT-PACKARD® Company.

In some examples, upon selecting the cloud object 14 generated by the resource design system 4, the service repository 20 can be programmed to pass the cloud object 14 (and in some examples, separate model documents) to N number of provisioning engines 30 to deploy and/or instantiate an accessible cloud element 28 in the resource pool 16, where N is an integer greater than or equal to one. In other examples, upon selecting the cloud object 14 generated by the resource design system 4, the service repository 20 can be programmed to pass the cloud object 14 (and in some examples, separate model documents) to a provisioning engine orchestrator 31 that can communicate and manage the N number of provisioning engines 30.

In some examples, each provisioning engine 30 of the N number of provisioning engines 30 can be employed to instantiate a cloud element of the accessible cloud element 28 based on a given model document of a cloud object 14, wherein the given model document defines the specification for a given layer in the cloud. For instance, in some examples, provisioning engine 1 (e.g., a hardware provisioning engine) can instantiate a cloud element of the cloud object by employing the hardware layer of the cloud, while provisioning engine 2 (e.g., an infrastructure provisioning engine) can instantiate a cloud element of the accessible cloud element 28 by employing the infrastructure layer of the cloud. Further, after instantiation of the accessible cloud element 28, the lifecycle management operations can continue to be controlled by the N number of provisioning engines 30.

In some examples where the service repository 20 passes the cloud object to each of the N number of provisioning engines 30, each of the N number of provisioning engines 30 can be programmed to interpret a portion of the cloud object 14 (and associated model documents) that is understandable for a given one of the N number of provisioning engines 30. Moreover, relationships between layers of the cloud that are identified in the cloud object 14 can be employed by a given provisioning engine 30 to link together cloud elements of the accessible cloud element 28 and/or to wait for parameters that can result from context or from instantiation of a cloud element of the accessible cloud element 28 by another provisioning engine 30. In this manner, the relationships between cloud layers can characterize an orchestration of the N number of provisioning engines at each layer of the cloud.

As noted, in other examples the service repository passes the cloud object 14 to the provisioning engine orchestrator 31 which is programmed to receive the cloud object 14 and the model documents. The provisioning engine orchestrator 31 can provide an orchestration of requests to the N number of provisioning engines 30 and the provisioning engine 31 can choreograph a time and/or order that each of the N number of provisioning engines 30 (or some subset thereof) performs. Additionally, the provisioning engine orchestrator 31 can control when and how a result of a previous stage (e.g., instantiation by a given one of the N number of provisioning engines 30) can affect a next stage (e.g., instantiation by another one of the N number of provisioning engines 30). In this example, the provisioning engine orchestrator 31 can parse the cloud object 14 and the associated model documents to pass a portion of the cloud object 14 that is understandable by a given one of the N number of provisioning engines 30. Additionally, parameters for a given provisioning engine 30 N number of provisioning engines 30 can be set by the provisioning engine orchestrator 31 based on parameters provided by another provisioning engine 30 of the N number of provisioning engines 30. Such parameters could include, for example, an IP address of an instantiated server that can be employed to install a platform. Each of the N number of provisioning engines 30 can be programmed to interpret the portion of the cloud object 14 (and associated model documents) that is passed to a respective provisioning engine. Further, the provisioning engine orchestrator 31 can pace operations of each of the N number of provisioning engines 30 to ensure that that specific tasks that cannot and/or should not be done in parallel are completed in an appropriate order. Thus, relationships between layers of the cloud that are identified in the cloud object 14 can be employed by a given provisioning engine 30 to link together cloud elements of the accessible cloud element 28 and/or to wait for parameters from the provisioning engine orchestrator 31 that can result from context or from instantiation of a cloud element of the accessible cloud element 28 by another provisioning engine 30. In this manner, the relationships between cloud layers can characterize an orchestration of the N number of provisioning engines at each layer of the cloud.

In one example, the cloud object 14 can include a model document for the hardware layer, and an infrastructure layer, a platform layer and an application layer. Thus, in this example, the cloud object 14 can be employed to instantiate the accessible cloud element 28 at the infrastructure layer. In such an example, provisioning engine 1 (e.g., the hardware provisioning engine) can employ the model document associated with the hardware layer and instantiate the prescribed hardware cloud element configurations at the hardware layer. In some examples, a cloud element such as the hardware element can represent a combination of cloud elements. However, for purposes of simplification of explanation, only one cloud element per layer of the cloud is described herein. Provisioning engine 2 (e.g., the infrastructure provisioning engine) can employ the model document associated with the infrastructure layer, the cloud element instantiated at the hardware layer and the data characterizing the relationship between cloud elements in each layers to instantiate a cloud element at the infrastructure layer.

Further, provisioning engine 3 (e.g., a platform provisioning engine) can receive the model document associated with the platform layer, and can employ the model document associated with the platform layer, the data characterizing the relationship between cloud elements in each layers and the cloud element instantiated at the infrastructure layer to instantiate a cloud element at the platform layer. Still yet further, provisioning engine 4 (e.g., an application provisioning engine) can receive the model document associated with the application layer, and can employ the model document associate the application layer the data characterizing the relationship between layers, and the cloud element at the infrastructure layer to instantiate a cloud element at the application layer. Moreover, the cloud element instantiated at the application layer can (in the present example) be the accessible cloud element 28.

In other examples, as noted, the cloud object 14 can include model documents for less than all of the layers of the cloud. For instance, in one example, the cloud object 14 can be employed to instantiate the accessible cloud element 28 at the platform layer, wherein the cloud object 14 can include a model document associated with the platform layer and a model document associated with the infrastructure layer of the cloud. In such a situation, the provisioning engine 1 (e.g., the hardware provisioning engine) can employ a generic template (or blueprint) and the data characterizing the relationship between layers of the cloud to instantiate a cloud element at the hardware layer. In a similar manner, provisioning engine 2 (e.g., the infrastructure provisioning engine) can employ the cloud element instantiated at the hardware layer, another generic template and the data characterizing the relationship between layers to instantiate a cloud element at the infrastructure layer. Still further, a cloud element at the platform layer can be instantiated by provisioning engine 3 (e.g., a platform provisioning engine) in a manner described herein. In this manner, a designer of the cloud object 14 may omit a specification for certain cloud elements of the cloud.

Upon instantiation of the accessible cloud element 28, the accessible cloud element 28 can be useable. For instance, a client 32 can access the accessible cloud element 28 via the cloud 6. In some examples, the client 32 can be implemented as a thin client (e.g., a computer terminal with a web browser) or a fat client (e.g., a computer, a smart phone, a tablet, etc.). Moreover, in some examples, the accessible cloud element 28 can be managed by the client 32. For instance, the accessible cloud element 28 could be designed such that the client 32 can monitor a status of the accessible cloud element 28, duplicate the accessible cloud element 28, de-instantiate (e.g., shut down) the accessible cloud element 28, etc. Further, in some examples, the accessible cloud element 28 can be designed such that the client 32 can move, and/or back up the accessible cloud element 28.

By employment of the system 2, a designer (or multiple designers) of the cloud object 14 can control the features of the cloud object 14 at each layer (or some subset thereof) based on what is designed as a model for each layer. As previously noted, the cloud designer 12 can provide a common user experience (UE) during the design of the cloud object 14 for designing each layer of the accessible cloud element 28. By employing the cloud designer 12, a user of the cloud designer can employ a common taxonomy for related cloud elements, operations and associated parameters. Moreover, composition of cloud elements and/or the establishment of relationships between cloud elements can be completed in a similar manner. Further, the cloud designer 12 can be programmed such that views can depict cloud elements across layers and relationships across layers. Further, as explained, the cloud object 14 designed by the cloud designer 12 can be deployed/instantiated and managed by the N number of provisioning engines 30.

Further, since each layer of the cloud object 14 can be defined prior to instantiation of the accessible cloud element 28, the cloud designer 12 can validate the specification in the plurality of model documents of the cloud object 14.

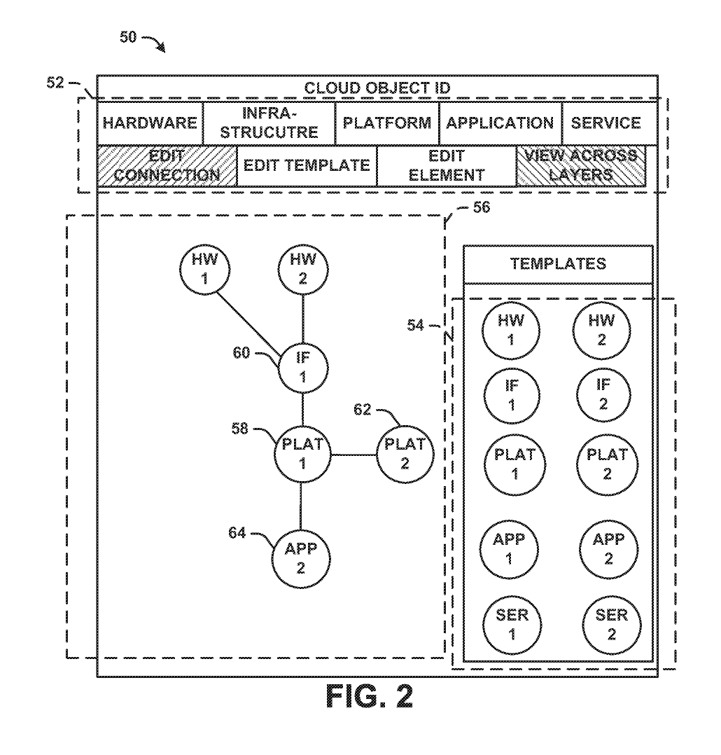

FIG. 2 illustrates an example of a GUI 50 that could be employed, for example, to generate and/or edit a cloud object, such as the cloud object 14 illustrated in FIG. 1. In the present example, a cloud object identifier (labeled in FIG. 2 as “CLOUD OBJECT ID”) can identify a filename of the cloud object. The GUI 50 can be employed, for example, to implement the interface 18 of the cloud designer 12 illustrated in FIG. 1. The view depicted in GUI 50 can represent a global view illustrating cloud elements (or a subset of cloud elements) at each layer and the relationships associated with each cloud element.

A plurality of virtual buttons 52 can be employed to select a particular layer of the cloud object to edit. In the present example, the virtual buttons 52 include the hardware layer (labeled in FIG. 2 as “HARDWARE”), the infrastructure layer (labeled in FIG. 2 as “INFRASTRUCTURE”), the platform layer (labeled in FIG. 2 as “PLATFORM”), the application layer (labeled in FIG. 2 as “APPLICATION”) and the services layer (labeled in FIGS. 2 as “SERVICE”). However, in other examples more or less layers can be included.

The GUI 50 can include a plurality of templates 54 that can be employed to represent cloud elements at each layer and/or pre-defined cloud elements across layers. For instance, in the present example, there are two templates 54 for each layer, but in other examples, more or less templates 54 for each layer can be included. Each template 54 can be stored, for example, as a model document. Each template 54 can represent, for example, a particular specification of a cloud element (e.g., a configuration and/or a function). In the present example, there are two hardware model templates 54, namely a first hardware model template (labeled in FIG. 2 as “HW 1”) and a second hardware model template (labeled in FIG. 2 as “HW 2”). Similarly, the present example includes a first infrastructure model template (labeled in FIG. 2 as “IF 1”) and a second infrastructure model template (labeled in FIG. 2 as “IF 2”). Additionally, the present example includes a first platform model template (labeled in FIG. 2 as “PLAT 1”) and a second platform model template (labeled in FIG. 2 as “PLAT 2”). Further, the present example includes a first application model template (labeled in FIG. 2 as “APP 1”) and a second application model template (labeled in FIG. 2 as “APP 2”). Further still, the present example includes a first service model template (labeled in FIG. 2 as “SER 1”) and a second service model template (labeled in FIG. 2 as “SER 2”).

The GUI 50 includes a virtual button 52 for editing and/or generating a template 54 (labeled in FIG. 2 as “EDIT TEMPLATE”), which virtual button 52 can be referred to as a template editing button. Upon selection of the template editing button, a text editor can be provided, wherein the specification of a given template 54 can be edited and/or generated. The specification of the given template 54 could be expressed, for example, in the TOSCA language. In some examples, the specification of a given template can be designed such that an output of the given template can combine different layers. As explained, the specification of the given template can alternatively be in any other format that allows expression of relationships between cloud elements within layers and across layers as well as providing a syntax for expressing each of the models. For instance, the specification could be implemented in a generic extensible markup language (XML).

The GUI 50 can include a virtual button 52 for providing a view across layers of the cloud object (labeled in FIG. 2 as “VIEW ACROSS LAYERS”). Selection of the view across layers virtual button can provide a view of the GUI with a layout of layer cloud elements and connections (representing relationships) between the layer cloud elements, including cloud elements on different layers of the cloud. In the present example, the view across layers virtual button has been selected.

Additionally, the GUI 50 includes a virtual button 52 for editing connections (labeled in FIG. 2 as “EDIT CONNECTIONS”) between cloud element for the cloud object, which virtual button 52 can be referred to as a connection editing button. Upon selection of the editing connections virtual button, templates 54 can be dragged and dropped to an editing area of the GUI 50 to generate a model document describing a cloud element. Additionally, the connections between the cloud elements can be added, modified and/or deleted. For instance, in the present example, a cloud element 58 based on the first platform model template can be connected to a cloud element 60 corresponding to the first infrastructure model template, a cloud element 62 corresponding to the second platform model template and a cloud element 64 corresponding to the second application model template. In this manner, links between layers CaO be added, modified and/or deleted.

The GUI 50 can also include a virtual button 52 that can be selected to edit the specification of a given cloud element (labeled in FIG. 2 as “EDIT ELEMENT”), which virtual button 52 can be referred to as an edit element button. For instance, upon selection of the edit element button, the given cloud element can be selected. Upon selection of the given cloud element, a text editor similar to the text editor employed for editing the templates 54 can be displayed. Accordingly, the specification of the given cloud element can be modified and/or generated. The specification of the given cloud element could be expressed, for example, in the TOSCA language, XLM or any other format that allows expression of relationships between cloud elements within layers and across layers as well as providing syntax for expressing each of the models. In this manner, the templates 54 can be extended.

Upon completion of the editing of the connections between the cloud elements in each layer and across layers, and the editing of the specification of the all the involved cloud elements in each layer, the cloud object can be saved and stored in a service repository (e.g., the service repository 20 illustrated in FIG. 1). Accordingly, the cloud object can be selected and instantiated into an accessible cloud element in a manner described with respect to FIG. 1. By employment of the GUI 50, a user can be provided a common user experience (UE) for the generation and modification of each layer of the could object. Accordingly, parameters for the instantiation of the accessible cloud element can be centrally controlled.

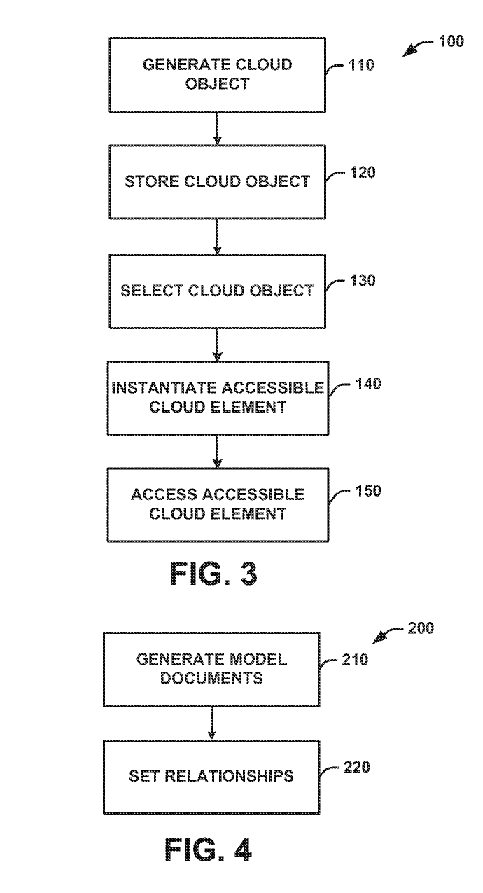

In view of the foregoing structural and functional features described above, example methods will be better appreciated with reference to FIGS. 3-5 and 7. While, for purposes of simplicity of explanation, the example methods of FIGS. 3-5 and 7 are shown and described as executing serially, it is to be understood and appreciated that the present examples are not limited by the illustrated order, as some actions could in other examples occur multiple times, in different orders and/or concurrently from that shown and described herein. Moreover, it is not necessary that all described actions be performed to implement a method.

FIG. 3 illustrates an example of a flow chart of an example method 100 for instantiating a cloud object to generate an accessible cloud element. The method 100 could be executed, for example, by a cloud system (e.g., the system 2 illustrated in FIG. 1). At 110, the cloud object can be generated by a cloud designer (e.g., by the cloud designer 12 illustrated in FIG. 1). The cloud object can include, for example, a plurality of model documents, wherein each model document is associated with a cloud element. The cloud object can also include data characterizing a relationship between cloud elements specified in the plurality of model documents. In some examples, the model documents can be integrated with the cloud object. In other examples, the model documents can be stored separately from the cloud object and referenced in the cloud object.

At 120, the cloud object can be stored at a service repository (e.g., the service repository 20 illustrated in FIG. 1). At 130, the cloud object can be selected by subscriber (e.g., the subscriber 26 illustrated in FIG. 1). In some examples, to select the cloud object, the subscriber can access an interface, such as a catalog of the service repository (e.g., a marketplace/storefront) and select the cloud object from a list of cloud objects. The catalog can include, for example, commercial/usage terms added to the cloud object in the service repository. The commercial/usage terms can include, for example, price, a service license agreement (SLA), a policy, etc.

At 140, an accessible cloud element can be instantiated by a plurality of provisioning engines (e.g., the provisioning engines 30 illustrated in FIG. 1), based on the cloud object. At 150, the accessible cloud element can be accessed, for example, by a client (e.g., the client 32 illustrated in FIG. 1).

FIG. 4 illustrates an example of a flow chart of an example method 200 to generate a cloud object (e.g., the cloud object 14 illustrated in FIG. 1). The method 200 can be employed to implement the generating of the cloud object 110 illustrated in FIG. 3. The method 200 can be implemented, for example, by a cloud designer (e.g., the cloud designer 12 illustrated in FIG. 1). At 210, model documents can be generated. Each model document can include a specification of a cloud element. Moreover, design of each model document in the cloud object can occur concurrently and/or sequentially. Further, in some examples, the model documents associated with the cloud object can be independently designed by different people on multiple computer systems. Still further, a given model document of the cloud object may be generated in a library that is useable by other designers to build and/or modify another model document of the cloud object at a different layer.

Each of the model documents, or some subset thereof, can be generated, for example, based on a template. Moreover, the specification in each model document could be written, for example, in the TOSCA language, XML language or any other format that provides syntax for expressing the relationships between cloud elements of the cloud object as well as syntax for expressing each model. At 220, relationships between the cloud elements corresponding to the model documents can be set (e.g. added, modified and/or deleted). The relationships can characterize the interaction between cloud elements of the cloud object. By employment of the method 200, a common user experience (UE) can be observed during the generation and/or modification of the cloud object at each layer of a cloud.

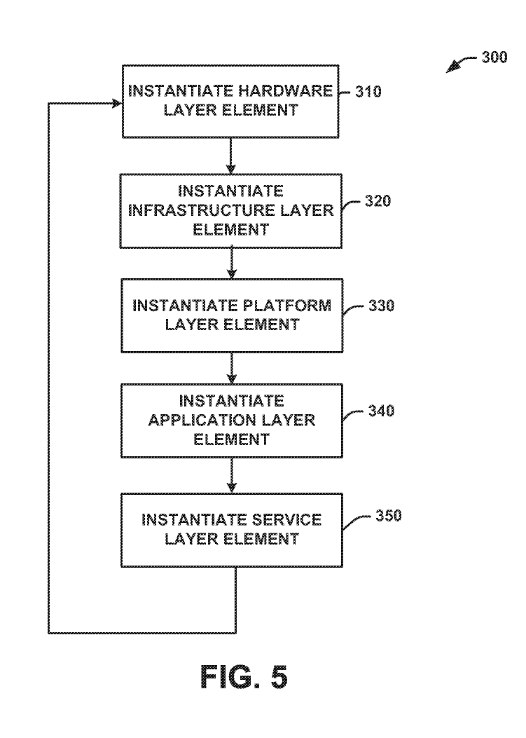

FIG. 5 illustrates an example of a flowchart of a method 300 for instantiating an accessible cloud element based on a cloud object (e.g., the cloud object 14 illustrated in FIG. 1). The method 300 could be employed, for example, to implement the instantiating 140 illustrated in FIG. 3 with a plurality of provisioning engines (e.g., the N number of provisioning engines 30 illustrated in FIG. 1). In some examples, each of the plurality of provisioning engines can receive the entire cloud object (e.g., from the service repository 20 illustrated in FIG. 1), and in some examples, associated model documents. In such a situation, each of the provisioning engines can be programmed to interpret an understandable portion of the cloud object. In these examples, parameters for insanitation of a given cloud element of the accessible cloud object can be determined from other provisioning engines and/or from context.

In other examples, a provisioning engine orchestrator (e.g., the provisioning engine orchestrator 31 illustrated in FIG. 1) can provide a portion of the cloud object and model documents that are understandable to each of the different provisioning engines (or some subset thereof). In these examples, the provisioning engine orchestrator can determine and provide parameters for instantiation of a given cloud element of the cloud object based on an output provided from an instantiated cloud element of the cloud object and/or based on context.

At 310, a first provisioning engine (e.g., a hardware provisioning engine) can instantiate a hardware layer cloud element based on a hardware model document of the cloud object and interconnections relationships identified in the cloud object between the hardware layer cloud element and other cloud elements. In some examples, the instantiation of the hardware layer cloud element can also be based on parameters derived from instantiation of another cloud element at the hardware layer and/or at another layer. At 320, a next provisioning engine (e.g., an infrastructure provisioning engine) can instantiate and infrastructure layer cloud element based on an infrastructure model document of the cloud object and relationships identified in the cloud object between the hardware layer cloud element and other cloud elements. In some examples, the instantiation of the infrastructure layer cloud element can also be based on parameters derived from instantiation of another cloud element at the infrastructure layer and/or at another layer.

At 330, a next provisioning engine (e.g., a platform provisioning engine) can instantiate an platform layer cloud element based on an platform model document of the cloud object and relationships identified in the cloud object between the platform layer cloud element and other cloud elements. In some examples, the instantiation of the platform layer cloud element can also be based on parameters derived from instantiate of another cloud element at the platform layer and/or at another layer. At 340, a next provisioning engine (e.g., an application provisioning engine) can instantiate an application layer cloud element based on an application model document of the cloud object and relationships identified in the cloud object between the platform layer cloud element and other cloud elements. In some examples, the instantiation of the application layer cloud element can also be based on parameters derived from instantiation of another cloud element at the application layer and/or at another layer. At 350, a next provisioning engine (e.g., a service provisioning engine) can instantiate a service layer cloud element based on an service model document of the cloud object and relationships identified in the cloud object between the service layer cloud element and other cloud elements. In some examples, the instantiation of the service layer cloud element can also be based on parameters derived from instantiation of another cloud element at the hardware layer and/or at another layer. In the present example, the service layer resource can be implemented as the accessible cloud element. However, in other examples, other cloud element, such as the infrastructure layer cloud element, the platform layer cloud element or the application layer cloud element can be employed to implement the accessible cloud element. Moreover, in some examples, the method 300 can return to 310.

It is noted that in the method 300, multiple cloud elements in each layer may need to be instantiated. Thus, in the method 300, the depicted actions may occur multiple times and/or in different orders, including, for example, back and forth performance of actions 310-350.

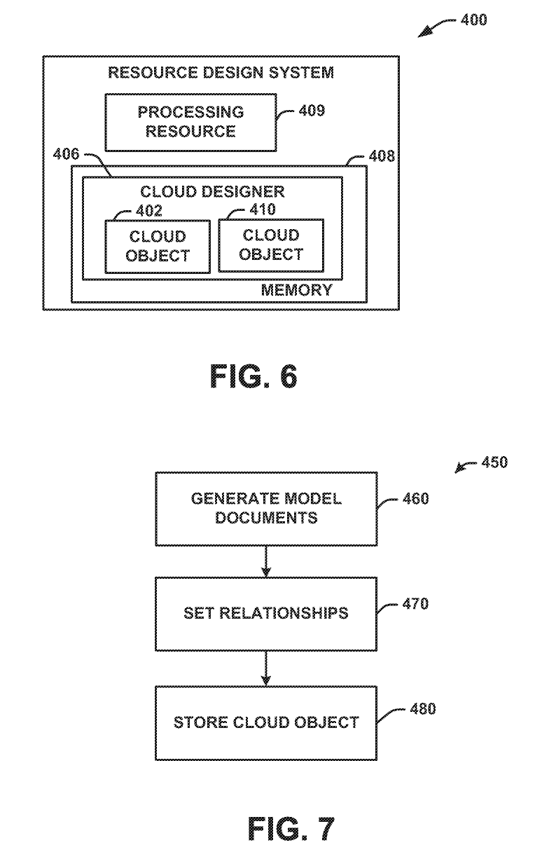

FIG. 6 illustrates an example of a system 400 that can be employed to generate a cloud object 402, such as the cloud object 14 illustrated in FIG. 1. The system 400 can include a cloud design system 404. The resource design system 404 can include a cloud designer 406 stored in a memory resource 408. The memory resource 408 can store machine executable instructions. A processing resource 409 can access the memory resource 408 and execute machine readable instructions. The cloud designer 406 can interact with an interface 410 to provide a common design user experience (UE) for designing cloud elements on different layers of a cloud with a common syntax. The common syntax is employable to express each cloud element of the cloud object and to express relationships between the cloud elements within and across layers of the cloud.

FIG. 7 illustrates an example of a method 450 for generating a cloud object. The method 450 could be implemented, for example, by the system 2 illustrated in FIG. 1. At 460, a plurality of model documents of a cloud object can be generated (e.g., by the cloud designer 12 illustrated in FIG. 1). At least two of the plurality of model documents can include a specification of a cloud element at different layers of a cloud. At 470, relationships that define an relationship between cloud resources corresponding to the plurality of model documents can be set (e.g., by the cloud designer 12 illustrated in FIG. 1). At 480, the cloud object can be stored in a memory resource of a service repository (e.g., the service repository 20 of FIG. 1).

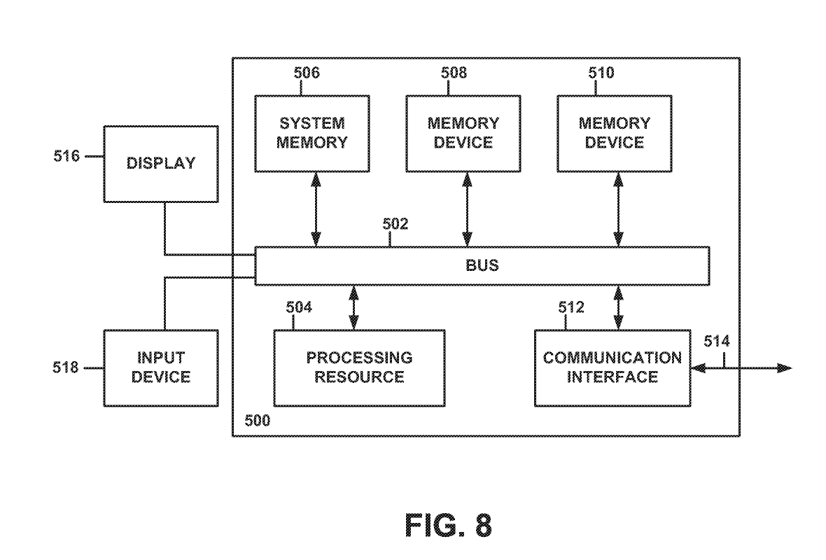

FIG. 8 is a schematic block diagram illustrating an example system 500 of hardware components capable of implementing examples disclosed in FIGS. 1-7, such as the resource design system 4, the service repository 20, the subscriber 26, the client 32 and the plurality of provisioning engines 30 of the system 2 illustrated in FIG. 1. The system 500 can include various systems and subsystems. The system 500 can be a personal computer, a laptop computer, a workstation, a computer system, an appliance, an application-specific integrated circuit (ASIC), a server, a server blade center, a server farm, a mobile device, such as a smart phone, a personal digital assistant, an interactive television set, an Internet appliance, etc.

The system 500 can include a system bus 502, a processing resource 504, a system memory 506, memory devices 508 and 510, a communication interface 512 (e.g., a network interface), a communication link 514, a display 516 (e.g., a video screen), and an input device 518 (e.g., a keyboard and/or a mouse). The system bus 502 can be in communication with the processing resource 504 and the system memory 506. The additional memory devices 508 and 510, such as a hard disk drive, a solid state drive, server, stand alone database, or other non-volatile memory, can also be in communication with the system bus 502. The system bus 502 operably interconnects the processing resource 504, the memory devices 506-510, the communication interface 512, the display 516, and the input device 518. In some examples, the system bus 502 also operably interconnects an additional port (not shown), such as a universal serial bus (USB) port. The memory device 506-510 can be employed to implement a computer readable medium.

The processing resource 504 can be a computing device and can include an application-specific integrated circuit (ASIC). The processing resource 504 executes a set of instructions to implement the operations of examples disclosed herein. The processing resource can include a processor core.

The additional memory devices 506, 508 and 510 can store data, programs, instructions, database queries in text or compiled form, and any other information that can be needed to operate a computer. The memories 506, 508 and 510 can be implemented as computer-readable media (integrated or removable) such as a memory card, disk drive, compact disk (CD), or server accessible over a network. In certain examples, the memories 506, 508 and 510 can comprise text, images, video, and/or audio.

Additionally, the memory devices 508 and 510 can serve as databases or data storage such as the database 22 in the service repository 20. Additionally or alternatively, the system 500 can access an external system (e.g., a web service) through the communication interface 512, which can communicate with the system bus 502 and the communication link 514.

In operation, the system 500 can be used to implement, for example, a client computer, a server, and at least some components of a network in a cloud. Computer executable logic for implementing the system, such as the memory resource 8 of the resource design system 4 illustrated in FIG. 1 and/or the database 22 of the service repository 20 can reside in the system memory 506, and/or in the memory devices 508 and/or 510 in accordance with certain examples. The processing resource 504 executes machine executable instructions originating from the system memory 506 and the memory devices 508 and 510. In such an example, the system memory 506 and/or the memory devices 508 and/or 510 could be employed, for example, to implement the memory resource 8 illustrated in FIG. 1. The term “computer readable medium” as used herein refers to a non-transitory medium that participates in providing instructions to the processing resource 504 for execution.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A system comprising a cloud designer stored in a memory resource to generate a cloud object for a cloud, wherein the cloud designer to interact with an interface to provide a common design user experience (UE) for designing cloud elements on different layers of the cloud with a common syntax, wherein the common syntax is employable to express each cloud element of the cloud object and to express relationships between cloud elements within and across layers of the cloud, wherein the interface is employable to configure and link each cloud element of the cloud object.

2. The system of claim 1, wherein cloud object comprises:
a plurality of model documents, wherein each model document of the plurality of model documents includes a specification of a cloud element at a given layer of a cloud, wherein at least two of the model documents of the plurality of model documents are associated with different layers of the cloud; and
data characterizing a relationship between cloud elements specified by the plurality of model documents.

3. The system of claim 2, further comprising a service repository coupled to a network to store the cloud object, wherein the service repository comprises a catalog that characterizes commercial and/or service usage terms for the cloud object, wherein the catalog is to provide a marketplace interface to select the cloud object.

4. The system of claim 3, wherein the service repository is to provide the cloud object with the corresponding model documents to a plurality of provisioning engines coupled to the network.

5. The system of claim 3, wherein the service repository is to provide the cloud object with the corresponding model documents to a provisioning engine orchestrator coupled to the network, the provisioning engine orchestrator to provide a given portion of the cloud object to a given provisioning engine of a plurality of provisioning engines, wherein the given provisioning engine is to instantiate a cloud element of the cloud object at a given layer based on the given portion of the cloud object, and the data characterizing the relationship between cloud elements specified by the plurality of model documents.

6. The system of claim 2, wherein a given model document of the plurality of model documents includes a reference to an artifact.

7. The system of claim 2, wherein the cloud designer is further to integrate and/or reference the plurality of model documents and the data characterizing the relationship between the cloud elements of the cloud object in a single file.

8. The system of claim 1, wherein the interface is to provide a global view of the cloud object, wherein the global view provides a graphical representation of each layer of the cloud object and relationships between each layer of the cloud object.

9. A method comprising:
generating a plurality of model documents of a cloud object, wherein at least two of the plurality of model documents include a specification of a cloud element at different layers of a cloud;
setting relationships that define an relationship between cloud elements corresponding to the plurality of model documents; and
storing the cloud object in a memory resource of a service repository.

10. The method of claim 9, wherein the specification included in each of the plurality of model documents is implemented in the topology and orchestration specification for cloud applications (TOSCA) language or the extensible markup language (XML).

11. The method of claim 9, further comprising:
providing each of a plurality of provisioning engines with the cloud object with the plurality of model documents;
instantiating a given layer cloud element based on a model document of the plurality of model documents, a defined relationship between cloud elements corresponding to the plurality of model documents and a given set of parameters; and
instantiating another layer cloud element based on another model document of the plurality of model documents, a defined relationship between cloud elements corresponding to the plurality of model documents and another set of parameters, wherein the given and the another layer cloud elements are instantiated on different layers of the cloud.

12. The method of claim 11, wherein the given and the another set of parameters are determined from one of context and an instantiation of a cloud element in the cloud object, and wherein the another cloud element of the cloud is instantiated after the instantiation of the given cloud element in the cloud object is completed.

13. The method of claim 9, further comprising:
providing the cloud object to a provisioning engine orchestrator;
providing a given portion of the cloud object and a given set of parameters to a given provisioning engine of the plurality of provisioning engines;
instantiating a given cloud element of the cloud object based on the given portion, the given set of parameters and a defined relationship between cloud elements corresponding to the plurality of model documents;
providing another portion of the cloud object and another set of parameters to a another provisioning engine of the plurality of provisioning engines; and
instantiating another cloud element of the cloud object based on the another portion, the another set of parameters and a defined relationship between cloud elements corresponding to the plurality of model documents.

14. The method of claim 13, wherein the given and the another set of parameters are determined by the provisioning engine orchestrator from one of context and an instantiation of a cloud element in the cloud object, and wherein the order and timing of instantiation of the given and the another cloud elements of the cloud object is controlled by the provisioning engine orchestrator.

15. A system comprising:
a resource design system coupled to a network, the resource design system comprising:
a memory resource to store computer executable instructions; and
a processing resource to access the memory resource and execute the computer executable instructions, the computer executable instructions comprising:
a cloud designer to generate a cloud object for a cloud, the cloud designer to interact with an interface to provide a common design user experience (UE) for designing cloud elements on different layers of the cloud with a common syntax, wherein the common syntax is employable to express each cloud element of the cloud object and to express relationships between cloud elements within and across layers of the cloud;
the cloud object comprising:
a plurality of model documents comprising:
a given model document that includes a specification for a given cloud element on the cloud for a given layer of the cloud, wherein the given model document includes a reference to an artifact;
another model document that includes a specification for another cloud element on the cloud for another layer of the cloud; and
data characterizing a relationship between the given cloud element and the another cloud element;
a service repository comprising:
a database to store the cloud object; and
a catalog with service usage and/or commercial terms to select the cloud object from a list of cloud objects; and
a plurality of provisioning engines to instantiate an accessible cloud element based on the cloud object.
